(19) United States
(12) Patent Application Publication
(10) Pub. No.: US 2014/0032045 A1
(43) Pub. Date: Jan. 30, 2014

(54) Vehicle Communication System, Access Data Device, and Telematics Communication System

(71) Applicant: Bayerische Motoren Werke Aktiengesellschaft, Muenchen (DE)

(72) Inventors: Mikhail SMIRNOV, Unterfoehring (DE); Mariano HERRERO, Burgkirchen an der Alz (DE)

(73) Assignee: Bayerische Motoren Werke Aktiengesellschaft, Muenchen (DE)

(21) Appl. No.: 14/042,850

(22) Filed: Oct. 1, 2013

Related U.S. Application Data
(63) Continuation of application No. PCT/EP2012/054732, filed on Mar. 16, 2012.

(30) Foreign Application Priority Data
Apr. 6, 2011 (DE) 10 2011 006 904.6

(51) Int. Cl. G06F 7/00

(52) U.S. Cl. CPC G06F 7/00
USPC 701/36

(57) ABSTRACT

A motor vehicle communication system using access-controlled telematic services in a motor vehicle has one or more telematic devices designed for executing telematic applications using at least one access-controlled telematic service. The vehicle communication system has a central access data device for managing prespecified access data for a plurality of the access-controlled telematic services used by the telematic applications. The central access data device has a first communication interface, and is designed to output a provision request for access data of the access-controlled telematic service, via the first communication interface, for each of the access-controlled telematic services, and to save access data for each of the access-controlled telematic services, the access data being provided to the first communication interface in response to the provision request, and to make the access data available via a prespecified internal interface to the telematic application using the respective access-controlled telematic service.

### CROSS REFERENCE TO RELATED APPLICATIONS

This application is a continuation of PCT International Application No. PCT/EP2012/054732, filed Mar. 16, 2012, which claims priority under 35 U.S.C. §119 from German Patent Application No. DE 10 2011 006 904.6, filed Apr. 6, 2011, the entire disclosures of which are expressly incorporated by reference herein.

### BACKGROUND AND SUMMARY OF THE INVENTION

The invention relates to a vehicle communication system, an access data device, and a telematic communication system for use in access-controlled telematic services in a motor vehicle.

Telematic systems are gaining prominence in vehicle technology. As such, telematic services are already used in motor vehicles, and enable new functionalities in the fields of route guidance, public safety services, and dynamic navigation assistance. Telematic services in automobile applications require communication between a communication device arranged in the motor vehicle and an infrastructure provided by the telematic service. The communication between the communication device arranged in the motor vehicle and, by way of example, a network service provider, is preferably realized via a wireless communication connection. In this case, a configuration can be implemented wherein access credentials are required for access to a telematic service provided by the network service provider—for example an authentication by way of specific access data.

The problem addressed by the invention is that of creating a vehicle communication system, an access data device, and a telematic communication system, each of which makes a contribution toward simplifying the provision of access data for access-controlled telematic services which are used in a motor vehicle.

According to a first aspect of the invention, the same is characterized by a vehicle communication system for the use of access-controlled telematic services in a motor vehicle. The vehicle communication system is arranged in the motor vehicle and has one or more telematic devices which are each designed to carry out one or more telematic applications which each use at least one access-controlled telematic service. In addition, the vehicle communication system has a central access data device for the purpose of managing prespecified access data which is used by the telematic applications in the motor vehicle. The central access data device has a first communication interface. The central access data device is designed to output a provision request for each access-controlled telematic service, for the access data of the access-controlled telematic service, via the first communication interface, and to save access data for each access-controlled telematic service. The access data is provided to the first communication interface in response to the provision request. The central access data device is designed to make the access data available via a prespecified, internal interface of the telematic application which is using the particular access-controlled telematic service.

The central access data device can advantageously contribute to making the access data for each of the access-controlled telematic services available in an application-specific and timely manner for the telematic applications. In addition, it can contribute to simplifying an expansion of the telematic services used in the motor vehicle, and to reducing the complexity of a telematic device, for the reason that it is possible to dispense with switching modules and/or software modules for the purpose of managing access data in the respective telematic device.

The central access data device is preferably designed to manage all access-controlled telematic services used in the motor vehicle. In this case, a telematic service which requires access authorization for the use thereof is termed an access-controlled telematic service. By way of example, the access data can include identification information which is specific to the vehicle, and/or identification information which is specific to the user of the vehicle, and/or a password. The access data can also include secret keys and/or digital certificates, for example. The access data can have an unlimited period of validity, or a limited period of validity. The access data which has an unlimited period of validity can also be termed static access data. The access data which has a limited period of validity can be termed dynamic access data. By way of example, dynamic access data can be used to better protect a network service server from unauthorized access.

The central access data device can have a memory device for the purpose of managing the access data, wherein the access data are stored in the memory device. In particular, the static access data can be saved in the memory device, such that the static access data can be read out of the memory device and made available to the respective telematic application when required, for example when the access data device is signaled that the respective telematic service should be activated. In the event that the respective telematic service requires dynamic access data, the dynamic access data can be requested by the central access data device. In addition, the dynamic access data can be temporarily stored in the memory device, read out of the memory device when required, and if the dynamic access data still has a remaining period of validity as prespecified, it can be directly provided to the respective telematic application.

In an initial configuration of the motor vehicle, for example when the motor vehicle is delivered from the factory and/or when the motor vehicle is sold, the access data for all desired telematic services, particularly for telematic services having access data with an unlimited period of validity, or a longer period of validity, can be requested and saved by the central access data device.

In one advantageous embodiment, the central access data device is designed to evaluate the access data of a telematic service currently being used—in such a manner that if the access data has a limited period of validity, a time point is determined according to the period of validity and to a prespecified update period—and to output, via the first communication interface, a new provision request for the updated access data of the telematic service currently being used, at the determined time point. This makes it possible for the updated access data to be made available in a timely manner—meaning prior to the expiry of the limited period of validity of the respective telematic application. The update period in this case can be fixed, or for example can be determined according to actual update times used in the past. In this way, for example, it is possible to advantageously prevent an interruption of a communication connection between the respective telematic application and a network service server due to the expiration of the period of validity of the access data.

According to a second aspect of the invention, the same is characterized by an access data device for the purpose of providing prespecified access data for at least a plurality of access-controlled telematic services which are used in a motor vehicle. The access data device is arranged outside of the motor vehicle, and has a second communication interface. The access data device is designed to receive a provision request for each set of prespecified access data for each access-controlled telematic service, via the second communication interface. In addition, the access data device is designed to assign the provision request to the motor vehicle and/or to a prespecified motor vehicle user, and to determine, in a manner specific to the vehicle and/or to the vehicle user, the respective access data in response to the provision request, and to provide said access data to the second communication interface.

In one advantageous embodiment, the access data device has a third communication interface. The access data device is designed to output a further provision request for basic access data for the access-controlled telematic service, for each of the access-controlled telematic services, via the third communication interface. The provision request is specific to the vehicle or to the vehicle user. The access device is further designed to temporarily store the basic access data of each telematic service which is provided in response to the further provision request at the third communication interface, and to determine the prespecified access data in a manner specific to the vehicle and/or to the vehicle user, for the prespecified telematic service, according to the basic access data. In this case, the third communication interface can be the same communication interface as the second communication interface, on a physical level. In this case, the basic access data can include the access data which provides authorization for use of the access-controlled telematic service. In this case, the access data device can take on the access data without modification.

As an alternative, the basic access data can include further data. By way of example, a user name and an access password can be used, not in their entirety, but only in part—for example several numbers or letters of which the same are composed. By way of example, the basic access data can include an instruction to only transmit the second, the first, and the fourth number of a pin. In this case, the access data device is designed to determine the access data according to the basic access data. In addition, it can be necessary that a password, for example, of the basic access data is encrypted, such that the access data includes an encrypted password.

According to a third aspect of the invention, the same is characterized by a telematic communication system for the purpose of using access-controlled telematic services in a motor vehicle. The telematic communication system includes a vehicle communication system according to the first aspect, and an access data device according to the second aspect. The first communication interface of the central access data device can be linked to the second communication interface of the access data device via at least one prespecified network connection.

Other objects, advantages and novel features of the present invention will become apparent from the following detailed description of one or more preferred embodiments when considered in conjunction with the accompanying drawing.

### BRIEF DESCRIPTION OF THE DRAWING

FIG. 1 is a block diagram illustration of one embodiment of a telematic communication system, according to the invention.

### DETAILED DESCRIPTION OF THE DRAWING

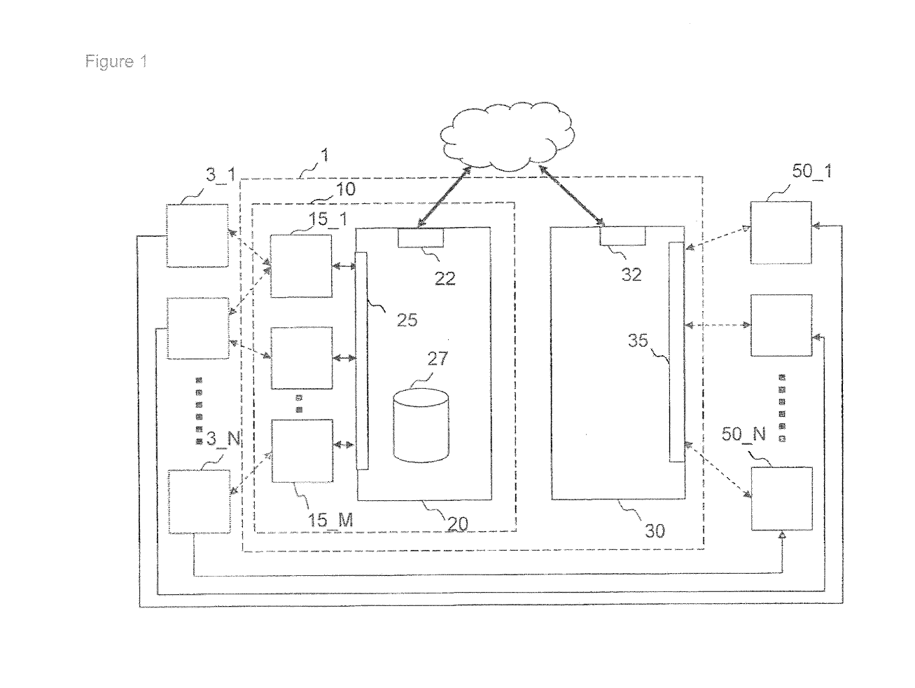

A telematic communication system 1 (FIG. 1) has a vehicle communication system 10 arranged in a motor vehicle, and an access data device 30 arranged outside the motor vehicle.

The vehicle communication system 10 has one or multiple telematic devices 15_1, 15_M which are designed for the purpose of executing at least one telematic application which uses at least one access-controlled telematic service 3_1, 3_N. The at least one telematic application includes, by way of example, a fleet management service, a route planning service, remote diagnostics, theft protection, the transmission of electronic mail, and/or access to databases outside the vehicle. Each telematic device 15_1, 15_M can include an independent switching device or a part of a central computer unit, for example. In addition or as an alternative thereto, each telematic device 15_1, 15_M can have a software module which is executed by a computer unit. Each telematic device 15_1, 15_M can have at least one network connection device, and/or each telematic device 15_1, 15_M can be functionally assigned to the at least one network connection device such that each telematic application of the telematic device 15_1, 15_M can be linked to a network service server via a prespecified network for the purpose of accessing the at least one access-controlled telematic service 3_1, 3_N.

In addition, the vehicle communication system 10 has a central access data device 20 for the purpose of managing prespecified access data for at least a plurality of the access-controlled telematic services 3_1, 3_N which are used by the telematic applications in the motor vehicle. The central access data device 20 has a first communication interface 22, and is designed to output a provision request for the access data of the access-controlled telematic service, via the first communication interface 22, for each of the access-controlled telematic services 3_1, 3_N, and to save access data for each of the access-controlled telematic services 3_1, 3_N, said access data being provided to the first communication interface 22 in response to the provision request, and to make said access data available via a prespecified internal interface 25 to the telematic application which uses the respective access-controlled telematic service 3_1, 3_N.

The central access data device 20 can be designed to evaluate the access data of a telematic service 3_1, 3_N currently in use, in such a manner that if the access data has a limited period of validity, a time point is determined according to the period of validity and to a prespecified update period, and to output a new provision request for the updated access data of the telematic service 3_1, 3_N currently in use, via the first communication interface 22, at the determined time point.

The access data device 30 is preferably arranged in a stationary position, for example in a service center of the motor vehicle manufacturer or an OEM partner of the motor vehicle manufacturer. The access data device 30 can have a computer unit, for example. The access data device 30 has a second communication interface 32 which can be linked to the first communication interface 22 of the central access data device 20 via at least one prespecified network connection. The at least one network connection preferably comprises a wireless communication connection.

The access data device 30 is designed to receive a provision request for each set of prespecified access data for each access-controlled telematic service 3_1, 3_N, via the second communication interface 32. In addition, the access data device 30 is designed to assign the provision request to the motor vehicle and/or to a prespecified motor vehicle user, and to determine, in a manner specific to the vehicle and/or to the vehicle user, the respective access data in response to the provision request, and to provide said access data to the second communication interface 32.

In addition, the access data device 30 can have a third communication interface 35, and by way of example can be designed to output a further provision request for basic access data for the access-controlled telematic service 3_1, 3_N, for each of the access-controlled telematic services 3_1, 3_N, via the third communication interface 35. The provision request is specific to the vehicle or to the vehicle user. The access data device 30 is further designed to temporarily store the basic access data of each telematic service 3_1, 3_N which is provided in response to the further provision request at the third communication interface 35, and to determine the prespecified access data in a manner specific to the vehicle and/or to the vehicle user, for the prespecified telematic service 3_1, 3_N, according to the basic access data. In this case, the third communication interface 35 can be the same communication interface as the second communication interface 32, on a physical level.

By way of example, the third communication interface 35 of the access data device 30 can be able to link via a further prespecified network connection to a prespecified service authorization control device 50_1, 50_N for each of the access-controlled telematic services 3_1, 3_N of a service provider, in order to request the basic access data of each access-controlled telematic service 3_1, 3_N. The service authorization control device 50_1, 50_N can have a proxy component, for example. The proxy component can be used as an access point, for example, for an access-protected network which can comprise one or more network service servers. In this case, the network service servers of the access-protected network can only be reached via the proxy component. The proxy component can be designed, by way of example, to allow access to the access-protected network and therefore to a desired telematic service 3_1, 3_N according to an access authorization—for example the access data. The proxy component can make a contribution toward better protecting the network service server or servers from unauthorized access and manipulation.

### LIST OF REFERENCE NUMBERS

1 telematic communication system
3_1, 3_N telematic service
10 vehicle communication system
15_1, 15_M telematic device
20 central access data device
22 first communication interface
25 internal interface
27 memory device
30 access data device
32 second communication interface
35 third communication interface
50_1, 50_N service authorization control device

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A vehicle communication system for using access-controlled telematic services in a motor vehicle, the vehicle communication system comprising:
one or more telematic devices, arranged in the vehicle, each of which are designed for executing one or more telematic applications which each use at least one access-controlled telematic service; and
a central access data device, arranged in the vehicle, having a first communication interface, the central access data device being operatively configured to manage prespecified access data for at least a plurality of the access-controlled telematic services used by the telematic applications in the motor vehicle, wherein the central access data device is further configured to:
output a provision request for access data of the access-controlled telematic service, via the first communication interface, for each of the access-controlled telematic services,
save the access data for each of the access-controlled telematic services, said access data being provided to the first communication interface in response to the provision request, and
make said access data available via a prespecified internal interface to the telematic application which uses the respective access-controlled telematic service.

2. The vehicle communication system according to claim 1, wherein the central access data device is further configured to:
evaluate the access data of a telematic service currently in use, such that if the access data has a limited period of validity, a time point is determined according to the period of validity and to a prespecified update period, and
output a new provision request for the updated access data of the telematic service currently in use, via the first communication interface and at the determined time point.

3. A data device for providing prespecified access data for at least a plurality of access-controlled telematic services used in a motor vehicle, comprising:
an access data device, arranged outside of the motor vehicle, having a second communication interface, wherein the access data device is operatively configured to:
receive a provision request for each set of prespecified access data for each access-controlled telematic service, via the second communication interface,
assign the provision request to at least one of the motor vehicle and a prespecified motor vehicle user, and
determine, in a manner specific to at least one of the motor vehicle and the prespecified motor vehicle user, the respective access data in response to the provision request, and to provide said access data to the second communication interface.

4. The device according to claim 3, wherein the access data device further comprises:
a third communication interface, wherein the access data device is further operatively configured to:
output a further provision request for basic access data for the access-controlled telematic service, for each of the access-controlled telematic services, via the third communication interface, said provision request being specific to the motor vehicle or to the prespecified motor vehicle user,
temporarily store the basic access data of each telematic service, said access data being provided in response to the further provision request at the third communication interface, and
determine the prespecified access data in a manner specific to the at least one of the motor vehicle and the prespecified motor vehicle user, for the prespecified telematic service, according to the basic access data.

5. A telematic communication system for using access-controlled telematic services in a motor vehicle, the system comprising:
one or more telematic devices, arranged in the vehicle, each of which are designed for executing one or more telematic applications which each use at least one access-controlled telematic service;
a central access data device, arranged in the vehicle, having a first communication interface, the central access data device being operatively configured to manage prespecified access data for at least a plurality of the access-controlled telematic services used by the telematic applications in the motor vehicle, wherein the central access data device is further configured to:
output a provision request for access data of the access-controlled telematic service, via the first communication interface, for each of the access-controlled telematic services,
save the access data for each of the access-controlled telematic services, said access data being provided to the first communication interface in response to the provision request, and
make said access data available via a prespecified internal interface to the telematic application which uses the respective access-controlled telematic service, and
an access data device, arranged outside of the motor vehicle, having a second communication interface, wherein the access data device is operatively configured to:
receive a provision request for each set of prespecified access data for each access-controlled telematic service, via the second communication interface,
assign the provision request to at least one of the motor vehicle and a prespecified motor vehicle user, and
determine, in a manner specific to at least one of the motor vehicle and the prespecified motor vehicle user, the respective access data in response to the provision request, and to provide said access data to the second communication interface, wherein the first communication interface of the central access data device is linkable to the second communication interface of the access data device via at least one prespecified network connection.

6. The telematic communication system according to claim 5, wherein the central access data device is further configured to:
evaluate the access data of a telematic service currently in use, such that if the access data has a limited period of validity, a time point is determined according to the period of validity and to a prespecified update period, and
output a new provision request for the updated access data of the telematic service currently in use, via the first communication interface and at the determined time point.

7. The telematic communication system according to claim 6, wherein the access data device further comprises:
a third communication interface, wherein the access data device is further operatively configured to:
output a further provision request for basic access data for the access-controlled telematic service, for each of the access-controlled telematic services, via the third communication interface, said provision request being specific to the motor vehicle or to the prespecified motor vehicle user,
temporarily store the basic access data of each telematic service, said access data being provided in response to the further provision request at the third communication interface, and
determine the prespecified access data in a manner specific to the at least one of the motor vehicle and prespecified motor the vehicle user, for the prespecified telematic service, according to the basic access data.

8. A method of operating a vehicle communication system that uses access-controlled telematic services in a motor vehicle equipped with one or more telematic devices configured to execute one or more telematic applications which each use an access-controlled telematic service, the method comprising the acts of:
providing a central access data device configured to manage prespecified access data for a plurality of the access-controlled telematic services used by the one or more telematic applications in the motor vehicle;
outputting, via the central access data device arranged in the motor vehicle, a provision request for access data of the access-controlled telematic service, via a first communication interface of the central access data device, for each of the access-controlled telematic services;
saving, in the central access data device, the access data for each of the access-controlled telematic services, wherein said access data is provided to the first communication interface in response to the provision request; and
making said access data available, by the central access data device via a prespecified internal interface, to the telematic application which uses the respective access-controlled telematic service.

9. The method according to claim 8, further comprising the acts of:
evaluating, by the central access data device, the access data of a telematic service currently in use such that, if the access data has a limited period of validity, a time point is determined according to the period of validity and to a prespecified update period; and
outputting, by the central access data device, a new provision request for updated access data of the telematic service currently in use, via the first communication interface and at the determined time point.

10. A method of operating an access data device that provides prespecified access data for a plurality of access-controlled telematic services used in a motor vehicle, the method comprising the acts of:
receiving, via a communication interface of the access data device arranged outside of the motor vehicle, a provision request for each set of prespecified access data for each access-controlled telematic service;
assigning, by the access data device, the provision request to at least one of the motor vehicle and a prespecified motor vehicle user; and
determining, by the access data device in a manner specific to the motor vehicle and/or the prespecified vehicle user, respective access data in response to the provision request, and providing said determined respective access data to the communication interface of the access data device.

11. The method according to claim 10, further comprising the acts of:
temporarily storing, by the access data device, basic access data of each telematic service, said basic access data being provided in response to a further provision request at a third communication interface, the third communication interface being of the access data device; and
determining the prespecified access data in a manner specific to the motor vehicle and/or the prespecified motor vehicle user, for the prespecified telematic service, according to the basic access data.
